(19) United States
(12) Patent Application Publication
(10) Pub. No.: US 2010/0272572 A1
(43) Pub. Date: Oct. 28, 2010

(54) METHOD FOR PRODUCING AN INTEGRALLY BLADED ROTOR, AND ROTOR

(75) Inventor: Erwin Bayer, Dachau (DE)

Correspondence Address: CROWELL & MORING LLP;INTELLECTUAL PROPERTY GROUP, P.O. BOX 14300, WASHINGTON, DC, 20044-4300, US

(73) Assignee: MTU Aero Engines GmbH, Munich (DE)

(21) Appl. No.: 12/809,985

(22) PCT Filed: Dec. 11, 2008
(86) PCT No.: PCT/DE08/02071

§ 371 Date: Jun. 21, 2010

(30) Foreign Application Priority Data
Dec. 22, 2007 (DE) 10 2007 062 557.1

(51) Int. Cl. F01D 5/30; B29C 65/06

(52) U.S. Cl. 416/213 R; 156/73.5

(57) ABSTRACT

A method for producing an integrally bladed rotor, as well as a rotor, is disclosed. A rotor support is composed of several disk-type rotor base bodies that are welded onto the blade ring.

This application claims the priority of International Application No. PCT/DE2008/002071, filed Dec. 11, 2008, and German Patent Document No. 10 2007 062 557.1, filed Dec. 22, 2007, the disclosures of which are expressly incorporated by reference herein.

### BACKGROUND AND SUMMARY OF THE INVENTION

The invention relates to a method for producing an integrally bladed rotor, in particular a gas turbine rotor, as well as the rotor itself.

Gas turbine rotors with integral blading are designated as blisks or blings regardless of whether there is a rotor or rotor support (called rotor base body in the following) that is disk-shaped or ring-shaped in cross section. Blisk is an abridgement of bladed disk and bling is an abridgement of bladed ring.

Producing gas turbine rotors with integral blading by milling from the solid is known from the prior art, something that is naturally very involved and expensive, which is why this method has been used only for relatively small gas turbine rotors.

Another method that has been used for large rotors is friction welding. In this case, rotor base bodies and the blades are produced separately and then friction welded together, in particular by linear friction welding. One advantage of production using welding is that rotor base bodies and turbine blades can be produced from different materials, which can be adapted to the different requirements of these sections of the rotor. Aligning the blades with the rotor base body in the joined state is difficult particularly in the case of friction welding, whereby one of the two parts must be moved relative to the other one.

The object of the invention is creating a method for producing an integrally bladed rotor, in which a simple friction welding process with a high level reproducibility and very low risk of error can be used. In addition, the parts being joined, particularly the blades, should be subject to as little stress as possible during joining. Furthermore, a rotor that is as simple as possible to produce should be disclosed.

To this end, the method according to the invention provides for the following steps:

a) Making available a blade ring with turbine blades,

b) Friction welding of a first rotor base body to the blade ring and

c) Friction welding of a second rotor base body to the blade ring.

In the case of the method according to the invention, the rotor support is composed of two parts, namely the first and the second rotor base body. This means that these two parts are not as big and heavy as a solid rotor support and must individually transmit less torque and force. It also means that the forces being applied when friction welding these lighter and smaller parts are less than when friction welding a large, individual rotor base body. For example, the compressive forces during friction welding can be reduced. In addition, it is possible to reduce the total weight of the rotor, particularly if the two rotor base bodies are spaced apart from one another, so that a type of hollow space structure is produced. Both rotor base bodies form a connection between the blade ring and the shaft.

With regard to the blade ring it must be mentioned that the blade ring can be a closed, circumferential ring, which is preferably the case. Alternatively, it would also be possible for the blade ring to be composed of individual segments, which are not connected to one another until the rotor base bodies are welded on.

According to a preferred embodiment, the blade ring has a formed-on crosspiece, onto which the first rotor base body is welded. For example, this crosspiece could be provided radially internally on the blade ring.

The crosspiece can have a weld lip on the side facing the first rotor base body, in other words, a section with a reduced cross section, which is used to make initial contact with the work piece being welded on.

The second rotor base body should be welded onto the front side of the crosspiece opposite from the first rotor base body so that the weld seams are adequately spaced apart from each other.

An embodiment that is especially advantageous in terms of the process provides that the blade ring is held during friction welding on a holding projection protruding from the blade ring. In particular, holding the parts during friction welding is especially critical because no forces that are too high may be transmitted to the unstable sections of the parts. The holding projections also permit the arrangement of an optimum holding geometry.

In this connection, it has proven to be advantageous, if the holding projection is provided radially internally on the blade ring and protrudes on the axial side.

The holding projection can also be a section or extension of the crosspiece so that the crosspiece performs a dual function.

A further variation of the method according to the invention provides that the holding projection is mechanically abraded after the first rotor base body is welded on in order to produce a joining surface for the second rotor base body. As a result, the construction volume is reduced as a whole, because the first and the second rotor base body can be arranged closer to one another.

During abrading, a weld lip with a reduced axial cross section for the second rotor base body can also be produced. Because a relatively precisely produced weld lip for the friction welding process is advantageous, an optimum joining surface can also be produced simultaneously during abrading to reduce the construction volume.

Because very little construction space is available in the region of the blade ring, in order to hold the rotor ring and to very carefully handle the sections of the rotor ring just near the turbine blades, the second friction welding process can preferably be carried out when the unit made of the blade ring and first rotor base body is held on the first rotor base body.

To this end, the first rotor base body can have a holding projection for positional fixation of the unit, which is mechanically abraded after the second rotor base body is welded on. This also makes it possible to make an optimum holding geometry available with simple means.

As already mentioned, in a welded-on state, the first and second rotor base bodies can at least partially be spaced apart from each other axially in order to form a hollow space between them.

This hollow space can also be designed as part of a cooling channel so that the rotor can be used advantageously particularly in the turbine region of a gas turbine. In addition, the invention is naturally also advantageous in producing a rotor for the compressor region of a gas turbine.

The ring section of the blade ring may be integrally cast or joined to the blades such that different materials may be used for the ring section and turbine blades.

The invention also relates to a rotor, in particular a gas turbine rotor, which is integrally bladed. The rotor has a blade ring with turbine blades protruding from it and fastened to it as well as at least two disk-shaped rotor base bodies, which are welded onto the blade ring, preferably by friction welding.

Additional features and advantages of the invention are disclosed in the following description and in the following drawings to which reference is made.

### BRIEF DESCRIPTION OF THE DRAWINGS

FIGS. 1 through 4 are half sections of the rotor according to the invention in different production steps, which depict the method according to the invention.

### DETAILED DESCRIPTION OF THE DRAWINGS

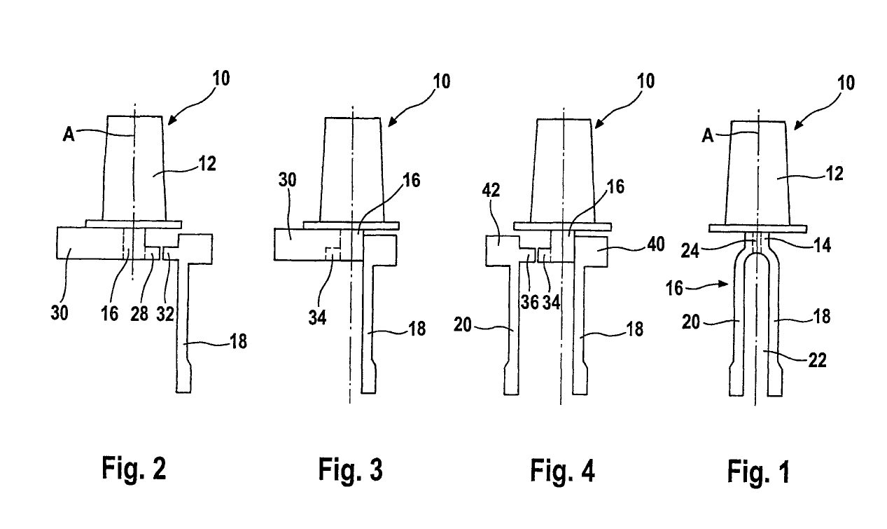

FIG. 1 depicts a half section of an integrally bladed rotor in the form of a gas turbine rotor.

The rotor includes several sections, namely a blade ring 10 with turbine blades 12 and a ring section 14 connecting the turbine blades 12 as well as a rotor support.

The rotor support includes a first rotor base body 18 as well as a second rotor base body 20. Both rotor base bodies 18, 20 are fastened on the blade ring 10 by friction welding.

As one can see from FIG. 1, the rotor base bodies 18, 20 are spaced apart from one another axially so that a hollow space 22 is formed between them, and the hollow space can be part of a cooling channel system, which reaches the turbine blades 12 via additional channels 24.

Producing the rotor will be explained in the following. The blade ring 10 is produced by the turbine blades 12 being attached to the ring section 16 by welding, soldering or casting of the ring section. The ring section 16 is normally made of a different material than the turbine blades 12.

The blade ring 10, in the following case more precisely the ring section 14, has several sections, as FIG. 2 shows. A ring-shaped crosspiece 16 is preferably precisely aligned with the center axis A of the turbine blade 12 and projects radially inwardly. Projecting in turn from one side of the crosspiece 16 is an extension, which serves as a weld lip 28. In the region of the weld lip 28, the ring section 14 has a smaller radial cross section than on the remainder of the crosspiece 16.

On the side of the crosspiece 16 opposite from the weld lip 28, the crosspiece has a ring-shaped holding projection 30, which, like the crosspiece 16, goes around in a closed, ring-shaped manner and forms a so-called continuation of the crosspiece 16. This holding projection 30 serves as a clamping ring and is fastened in a friction welding device.

In a first process step, the first rotor base body 18, which also has a weld lip 32, is rotary friction welded to the blade ring 10. FIG. 3 shows the unit that is generated after the friction welding.

Then the holding projection 30 is mechanically abraded, in particular turned on a lathe, except for a weld lip 34 that has a smaller cross section, which is depicted in FIG. 3 by broken lines.

In the next process step, which can be seen in FIG. 4, the second rotor base body 20, which like the first rotor base body 18 is equipped with a weld lip 36, is also welded onto the crosspiece 16.

The two rotor base bodies 18, 20 are preferably configured to be the same or mirror images.

The unit made of the first rotor base body 18 and blade ring 10 is fixed on a holding projection 40 during the second rotary friction welding process. The holding projection 40 is a rear-side, clamping-ring-like extension on the first rotor base body 18. The second rotor base body 20 also has a holding projection 42 as the case may be, which can serve as a bearing point for the application of torque.

After the second rotor base body 20 is welded onto the crosspiece 16, the rotor almost has its final form, only the two holding projections 40, 42 are still mechanically abraded, in particular turned on a lathe, so that ultimately the shape shown in FIG. 1 develops.

The rotor base bodies 18, 20 can be made of the same or different materials and also be made of the same or different materials as compared with those of the blade ring 10.

The cooling channels 24 may be produced after the rotor base bodies 18, 20 are welded on or even beforehand.

As FIG. 1 shows, the disk-type or ring-type rotor base bodies 18, 20 have an equal distance from the center axis A in the axial direction.

As an alternative, it would naturally also be possible to provide more than two rotor base bodies.

1-15. (canceled)

16. A method for producing an integrally bladed rotor, comprising the steps of:
making available a blade ring with turbine blades;
friction welding a first rotor base body to the blade ring; and
friction welding a second rotor base body to the blade ring.

17. The method according to claim 16, wherein the blade ring has a formed-on crosspiece bar, wherein the first rotor base body is welded on the crosspiece bar.

18. The method according to claim 17, wherein the crosspiece bar has a weld lip in a form of a section with a reduced radial cross-section on a side facing the first rotor base body.

19. The method according to claim 17, wherein the second rotor base body is welded onto a front side of the crosspiece bar opposite from the first rotor base body.

20. The method according to claim 16, wherein the blade ring is held during friction welding on a holding projection protruding from the blade ring.

21. The method according to claim 20, wherein the holding projection is provided radially internally on the blade ring and axially protrudes laterally.

22. The method according to claim 20, wherein the blade ring has a formed-on crosspiece bar, wherein the first rotor base body is welded on the crosspiece bar, and wherein the holding projection is an extension of the crosspiece bar.

23. The method according to claim 20, wherein the holding projection is mechanically abraded after the first rotor base body is welded on to produce a joining surface for the second rotor base body.

24. The method according to claim 23, wherein a weld lip with a reduced radial cross-section is produced on the holding projection for the second rotor base body.

25. The method according to claim 16, wherein a unit formed after the first rotor base body is welded on is held on the first rotor base body, and the second rotor base body is fastened to this unit by friction welding.

26. The method according to claim 25, wherein the first rotor base body has a holding projection for positional fixation of the unit, which is mechanically abraded after the second rotor base body is welded on.

27. The method according to claim 16, wherein in a welded-on state, the first and second rotor base bodies are at least partially spaced apart from each other axially and form a hollow space between them.

28. The method according to claim 27, wherein the hollow space is part of a cooling channel.

29. The method according to claim 16, wherein the blade ring has a ring section which is integrally cast or joined to the turbine blades.

30. An integrally bladed rotor, comprising:
a blade ring with turbine blades protruding from the blade ring and fastened to the blade ring; and
at least two disk-shaped rotor base bodies welded onto the blade ring.

31. The method according to claim 16, wherein the integrally bladed rotor is a gas turbine rotor.

32. The rotor according to claim 30, wherein the integrally bladed rotor is a gas turbine rotor.
